(19) United States
(12) Patent Application Publication
(10) Pub. No.: US 2012/0117884 A1
(43) Pub. Date: May 17, 2012

(54) HINGE APPARATUS AND DOOR OPENING AND CLOSING APPARATUS

(75) Inventor: Kazuyoshi Oshima, Tokyo (JP)

(73) Assignee: SUGATSUNE KOGYO CO., LTD., Chiyoda-ku, Tokyo (JP)

(21) Appl. No.: 13/201,163

(22) PCT Filed: Sep. 3, 2009
(86) PCT No.: PCT/JP2009/004346

§ 371 Date: Aug. 11, 2011

(30) Foreign Application Priority Data
Feb. 19, 2009 (JP) 2009-036890

(51) Int. Cl. E05D 7/00; E06B 11/06

(52) U.S. Cl. 49/381; 16/362; 16/354

(57) ABSTRACT

A body portion 41 of a hinge apparatus 4 is mounted to an inner surface of a side wall portion of a housing 2. Basal end portions of first and second links 42, 43 are rotatably mounted to the body portion 41. Distal end portions of the first and second links 42, 43 are rotatably mounted to a connecting member (not shown). A movable member 53 is connected to the connecting member such that the movable member 53 is movable in a left-right direction. A door 3 is mounted to the movable member 53. An outer gear portion 42a is disposed in the distal end portion of the first link 42. A rack portion 53 is formed in the movable member 53 such that a longitudinal direction of the rack portion 53 is oriented in the left-right direction. The outer gear portion 42a is engaged with the rack portion 53b.

### TECHNICAL FIELD

The present invention relates to a hinge apparatus and a door opening and closing apparatus in which the hinge apparatus is used.

### BACKGROUND ART

In a door opening and closing apparatus in which an opening of a housing is opened and closed by a door, a hinge apparatus is generally used between the housing and the door. As mentioned in the Patent Document 1 listed below, the hinge apparatus includes at least two links, i.e., first and second links. Basal end portions of the first and second links are rotatably connected to one side portion, i.e., a left side portion, for example, of the housing near the opening of the housing. Distal end portions of the first and second links are rotatably connected to a connecting member. The housing, the first link, the second link and the connecting member constitute a parallel link mechanism. The door is connected to the connecting member such that the door can be rectilinearly moved in a left-right direction.

To open the door in the door opening and closing apparatus in which the hinge apparatus having the above mentioned construction is used, the door in the closed position is moved to the near side. This causes the first and second links to be rotated about respective basal end portions, thereby casing the connecting member and the door to be moved to the left while at the same time being moved forward (a movement in the left-right direction while at the same time being moved in a front-rear direction is referred to as a swinging movement hereinafter). When the first and second links are rotated to the limit, the door opens, and about two thirds of the opening of the housing is opened. When the door is rectilinearly moved to the left with respect to the connecting member to the open position, an entirety of the opening of the housing is opened. The opening of the housing can be closed by the door in the reverse order.

### PRIOR ART DOCUMENTS

### Patent Document

Patent Document 1: Publication of Japanese Patent No. 3773113

### SUMMARY OF INVENTION

### Technical Problem

In the conventional door opening and closing apparatus in which the hinge apparatus is used, two sequential steps are required to open the door, i.e., the door needs to be swingingly moved and then rectilinearly moved, making the opening and closing of the door troublesome.

### Solution to Problem

A first aspect of the present invention provides a hinge apparatus comprising: a base member; a first link, a basal end portion of the first link rotatably connected to the base member; a second link, a basal end portion of the second link rotatably connected to the base member; a connecting member rotatably connected to a distal end portion of the first link and a distal end portion of the second link, the base member, the first link, the second link and the connecting member constituting a parallel link mechanism; and, a movable member connected to the connecting member in a rectilinearly movable manner; wherein a rolling portion is disposed in one of the distal end portion of the first link and the connecting member, the rolling portion rotated accompanying a rotation of the first link with respect to the connecting member; a guide portion is disposed in the movable member, the guide portion extending in a direction of movement of the movable member; and, the movable member is rectilinearly moved with respect to the connecting member by the rolling movement of the rolling portion on the guide portion accompanying the rotation of the first link.

In this case, it is preferable that the rolling portion is a gear portion and the guide portion is a rack portion engageable with the gear portion.

It is acceptable that the gear portion is disposed in the distal end portion of the first link with an axis of the gear portion coinciding with a rotation axis of the first link with respect to the connecting member.

It is also acceptable that the gear portion is rotatably disposed in the connecting member, a rotation transmission mechanism is provided between the first link and the gear portion, the rotation transmission mechanism transmitting the rotation of the first link with respect to the connecting member to the gear portion. In this case, it is preferable that the rotation transmission mechanism comprises an inner gear portion and a pinion, the inner gear portion disposed in the distal end portion of the first link with an axis of the inner gear portion coinciding with the rotation axis of the first link with respect to the connecting member, the pinion being engageable with the inner gear portion, and the gear portion is non-rotatably connected to the pinion with the axis of the gear portion coinciding with an axis of the pinion.

A second aspect of present invention provides a door opening and closing apparatus comprising: a housing having an opening in an one end surface thereof; and a door mounted to the housing via a hinge apparatus such that the door is movable between a closed position and an open position, the door closing the opening when the door is in the closed position, the door opening the opening when the door is in the open position, the hinge apparatus comprising: a first link, a basal end portion of the first link rotatably connected to the housing; a second link, a basal end portion of the second link rotatably connected to the housing; and a connecting member rotatably connected to a distal end portion of the first link and a distal end portion of the second link, the housing, the first link, the second link and the connecting member constituting a parallel link mechanism; the door connected to the connecting member such that the door is movable in opening and closing directions generally along an one end surface in which the opening of the housing is formed; wherein a rolling portion is disposed in one of the distal end portion of the first link and the connecting member, the rolling portion rotated accompanying a rotation of the first link with respect to the connecting member; a guide portion is disposed in the door, the guide portion extending in the opening and closing directions; and, the door is moved in the opening and closing directions with respect to the connecting member by the rolling movement of the rolling portion on the guide portion accompanying the rotation of the first link.

In this case, it is preferable that the rolling portion is a gear portion and the guide portion is a rack portion engageable with the gear portion.

It is acceptable that the gear portion is disposed in the distal end portion of the first link with an axis of the gear portion coinciding with a rotation axis of the first link with respect to the connecting member.

It is also acceptable that the gear portion is rotatably disposed in the connecting member, a rotation transmission mechanism is provided between the first link and the gear portion, the rotation transmission mechanism transmitting the rotation of the first link with respect to the connecting member to the gear portion. In this case, it is preferable that the rotation transmission mechanism comprises an inner gear portion and a pinion, the inner gear portion disposed in the distal end portion of the first link with an axis of the inner gear portion coinciding with the rotation axis of the first link with respect to the connecting member, the pinion being engageable with the inner gear portion, and the gear portion is non-rotatably connected to the pinion with the axis of the gear portion coinciding with an axis of the pinion.

### Advantageous Effects of Invention

According to the present invention having the above-mentioned constructions, the rolling portion rolls on the guide portion at the same time the door is swingingly moved. This causes the door to be moved generally along the one end surface of the housing in which the opening is formed. In other words, the swinging movement and the rectilinear movement of the door are made at the same time. Therefore, the hinge apparatus and the door opening and closing apparatus according to the present invention have advantages in that the door can be opened and closed with less trouble.

### BRIEF DESCRIPTION OF DRAWINGS

FIG. 1 is a perspective view of a first embodiment of a door opening and closing apparatus according to the present invention, showing the door in a closed condition.

FIG. 2 is a perspective view of the first embodiment of the door opening and closing apparatus, showing the door in a half-open condition.

FIG. 3 is a perspective view of the first embodiment of the door opening and closing apparatus, showing the door in an open condition.

FIG. 4 is a partially omitted horizontal cross-sectional view of the first embodiment of the door opening and closing apparatus, showing the door in the closed condition.

FIG. 5 is a partially omitted horizontal cross-sectional view of the first embodiment of the door opening and closing apparatus, showing the door in the half-open condition.

FIG. 6 is a partially omitted horizontal cross-sectional view of the first embodiment of the door opening and closing apparatus, showing the door in the open condition.

FIG. 7 is a view on arrow X of FIG. 4.

FIG. 8 is a cross-sectional view along line X-X of FIG. 7.

FIG. 9 is a cross-sectional view along line Y-Y of FIG. 7.

FIG. 10 is a perspective view of a hinge apparatus used in the first embodiment of the door opening and closing apparatus.

FIG. 11 is an exploded perspective view of the hinge apparatus of FIG. 10.

FIG. 12 is a cross-sectional view similar to FIG. 4, showing a second embodiment of the door opening and closing apparatus according to the present invention.

FIG. 13 is a cross-sectional view, similar to FIG. 5, of the second embodiment of the door opening and closing apparatus.

FIG. 14 is a cross-sectional view, similar to FIG. 6, of the second embodiment of the door opening and closing apparatus.

FIG. 15 is a view on arrow X of FIG. 12.

FIG. 16 is a cross-sectional view along line X-X of FIG. 15.

FIG. 17 is a cross-sectional view along line Y-Y of FIG. 15.

FIG. 18 a perspective view of a hinge apparatus used in the second embodiment of the door opening and closing apparatus.

FIG. 19 is an exploded perspective view of the hinge apparatus of FIG. 18.

### DESCRIPTION OF EMBODIMENTS

A best mode for carrying out the present invention will be described hereinafter with reference to the drawings.

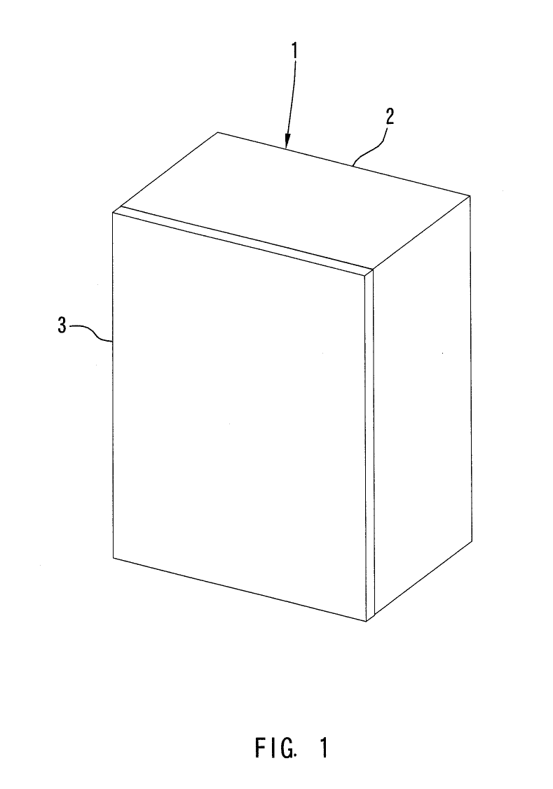

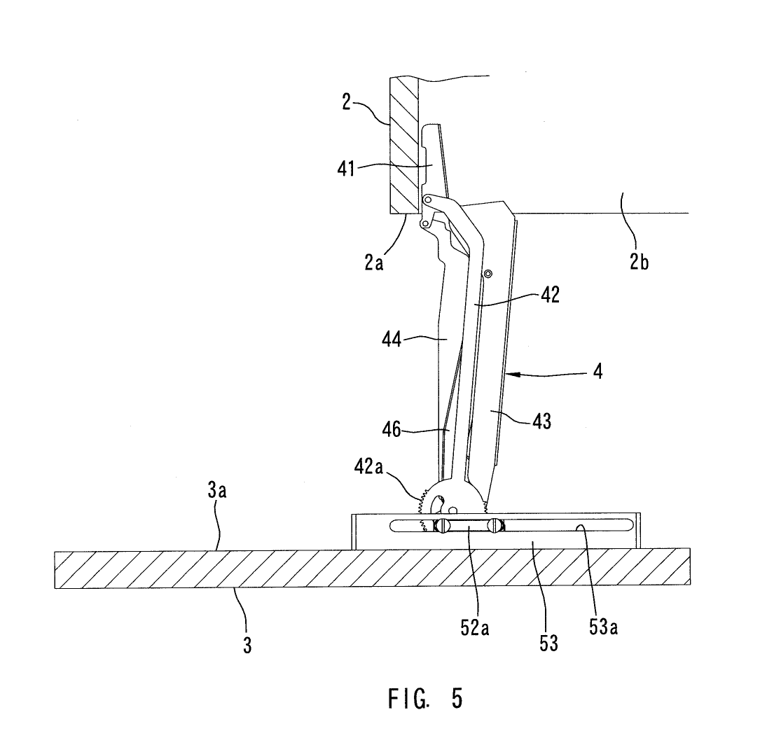

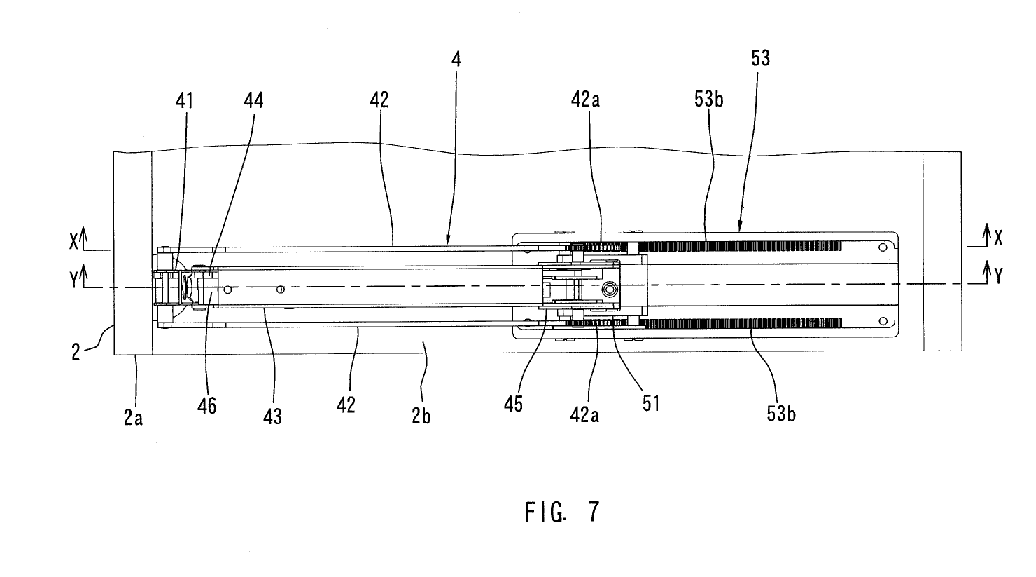

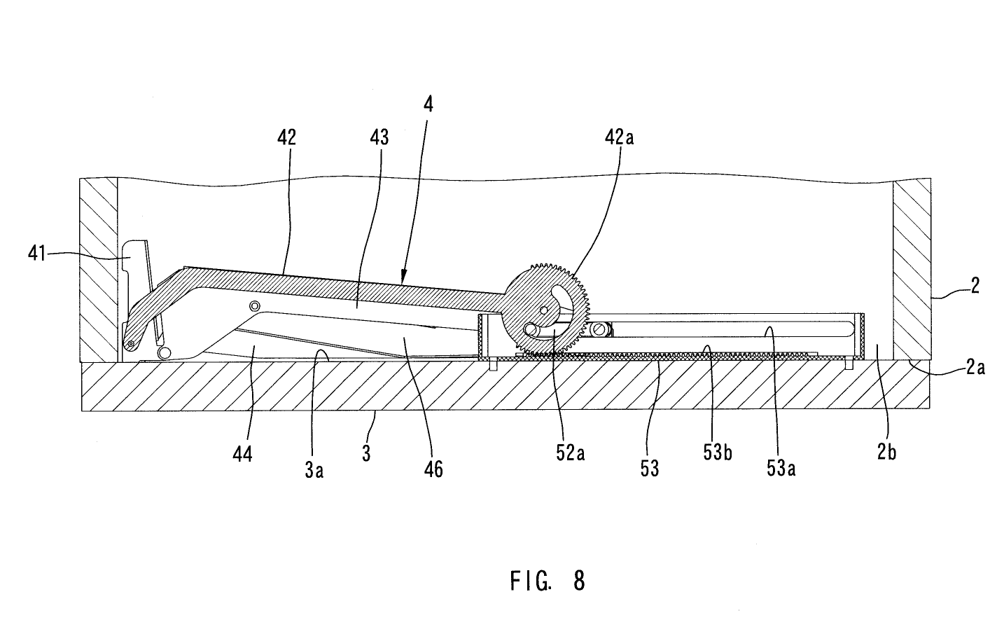

FIGS. 1 to 11 show a first embodiment of a door opening and closing apparatus according to the present invention. As shown in FIGS. 1 to 3, a door opening and closing apparatus 1 includes a housing 2, a door 3 and a hinge apparatus 4. The housing 2 has a quadrangular box configuration. The housing 2 has an opening 2b in a front surface (one end surface) 2a thereof. The housing 2 may have an opening in a side surface thereof either in the left or right or in a top surface thereof. The housing 2 may have other configurations than the quadrangular configuration.

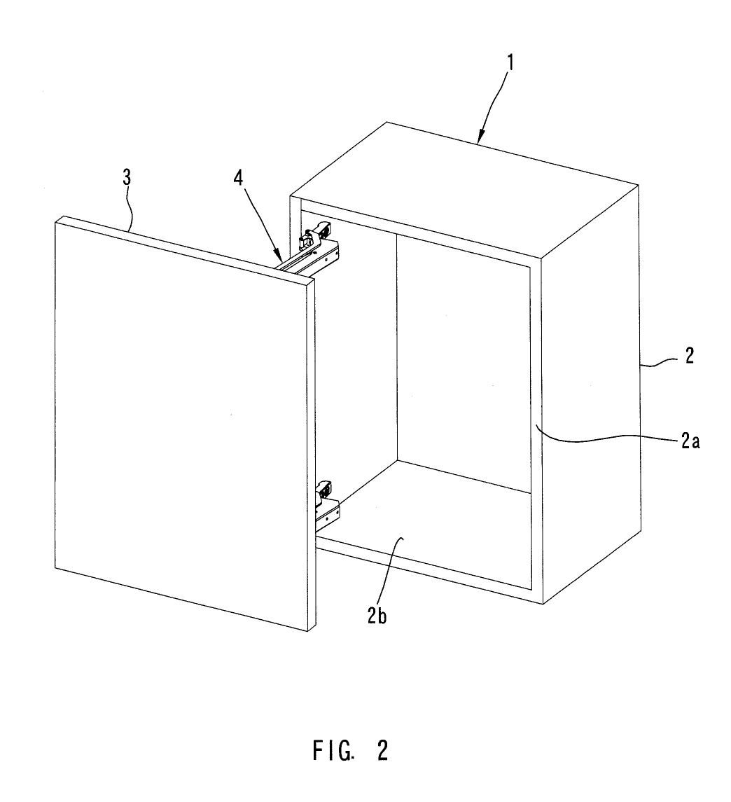

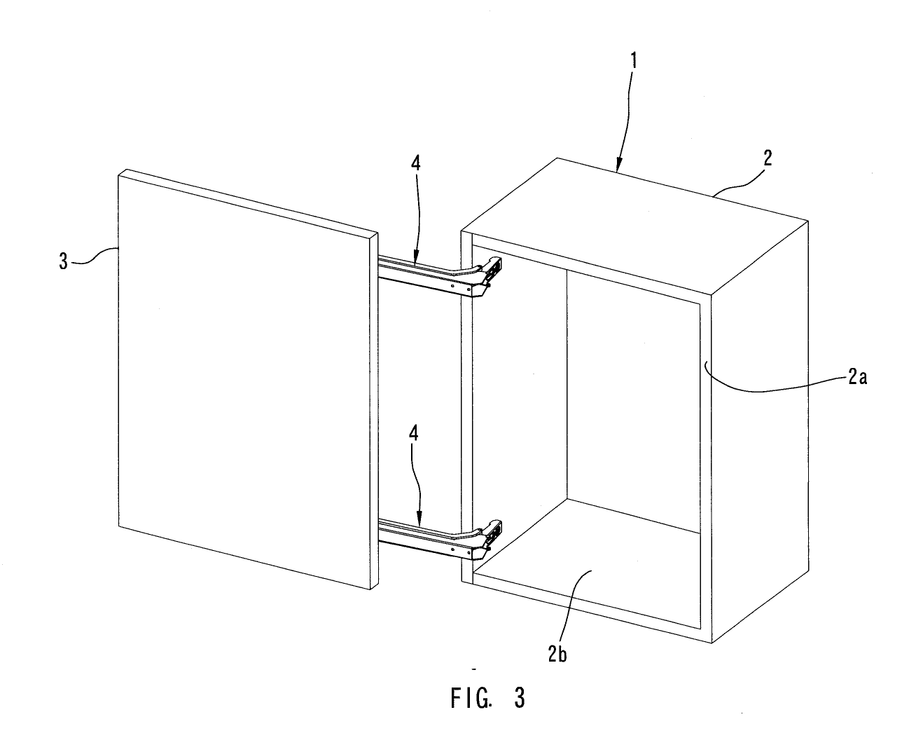

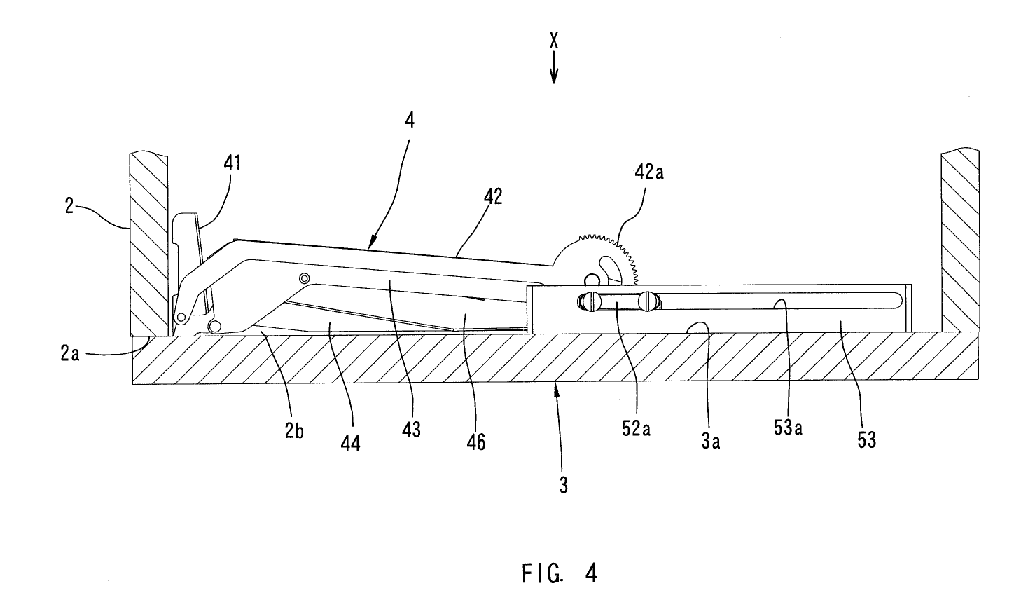

The door 3 has a flat plate configuration. A left side portion of the door 3 is connected to a left side portion of the housing 2 via the hinge apparatus 4. The door 3 can be moved between a closed position shown in FIG. 1 and an open position shown in FIG. 3. As shown in FIGS. 1 and 4, when the door 3 is in the closed position, a rear surface 3a of the door 3 is abutted against a front surface 2a of the housing 2, with the door 3 closing an entirety of the opening 2b. As the door 3 is moved from the closed position toward the open position, the opening 2b is gradually opened from a right side. At this time, the door 3 maintains a certain attitude while it is being moved. When the door 3 reaches a half-open position shown in FIG. 2, a portion of the opening 2b occupying about two thirds of the right side of the opening 2b when the housing 2 is viewed from front is opened. When the door 3 reaches the open position shown in FIG. 3, the entirety of the door 3 is spaced from the housing 2 to the left, opening the entirety of the opening 2b. The opening 2b can be closed by moving the door 3 in the opposite direction from the open position to the closed position.

A right side portion of the door 3 may be connected to a right side portion of the housing 2. In this case, the opening 2b can be opened by the door 3 being spaced from the housing 2 to the right. Similarly, an upper end portion of the door 3 may be connected to an upper end portion of the housing 2 or a lower end portion of the door 3 may be connected to a lower end portion of the housing 2. In these cases, the opening 2b can be opened by the door 3 being spaced from the housing 2 upwards or downwards.

The hinge apparatus 4 is provided for connecting the door 3 to the housing 2 such that the door 3 can be moved to open and close the housing 2. As shown in FIGS. 4 to 11, the hinge apparatus 4 includes a body portion (base member) 41. The body portion 41 is mounted to an inner surface of the left side portion of the housing 2 at a location near the front surface 2a. Particularly in this embodiment, a base board (not shown) is mounted on the inner surface of the left side portion of the housing 2, and the body portion 41 is removably mounted to the housing 2 via the base board. The body portion 41 may be directly mounted to the housing 2. The mounting location of the body portion 41 is changed according to the mounting location of the door 3. Therefore, the body portion 41 may be mounted on an inner surface of the right side portion, an inner surface of the upper portion or an inner surface of the lower portion of the housing 2.

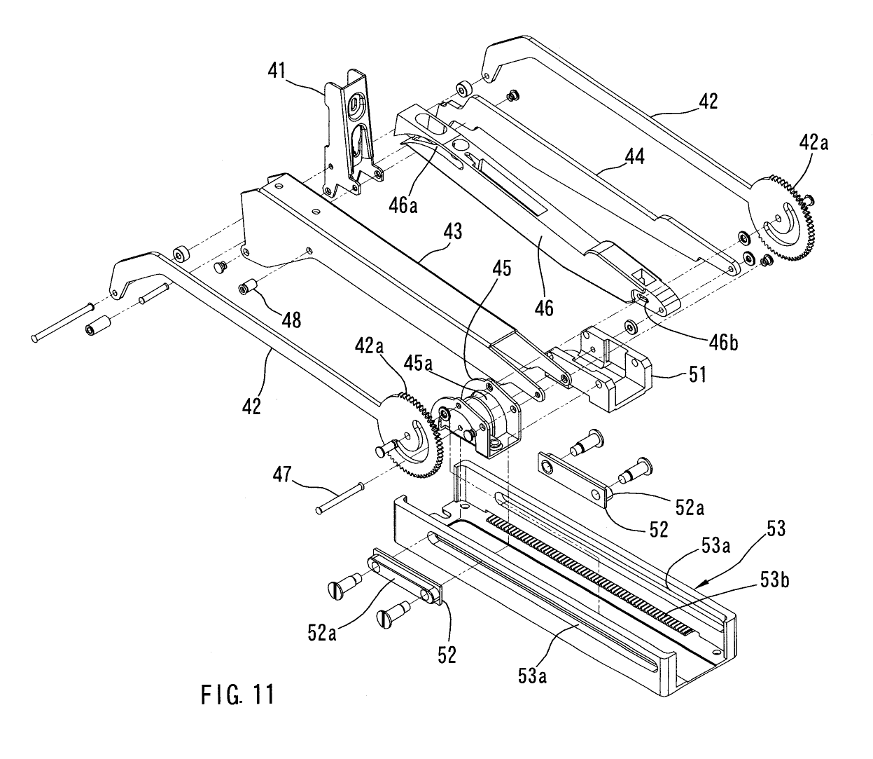

As particularly shown in FIG. 11, basal end portions of a pair of first links 42, 42, a second link 43 and a third link 44 are connected to an end portion of the body portion 41 on the opening 2b side such that the first links 42, 42, the second link 43 and the third link 44 can be rotated about three rotation axes extending in a top-bottom direction parallel to each other. The pair of first links 42, 42 are arranged to be spaced from each other in the top-bottom direction. The second link 43 is disposed between the pair of first links 42, 42. The second link 43 has a generally U-shaped cross-sectional configuration as will be described later, and a most portion of the third link 44 is received inside the second link 43.

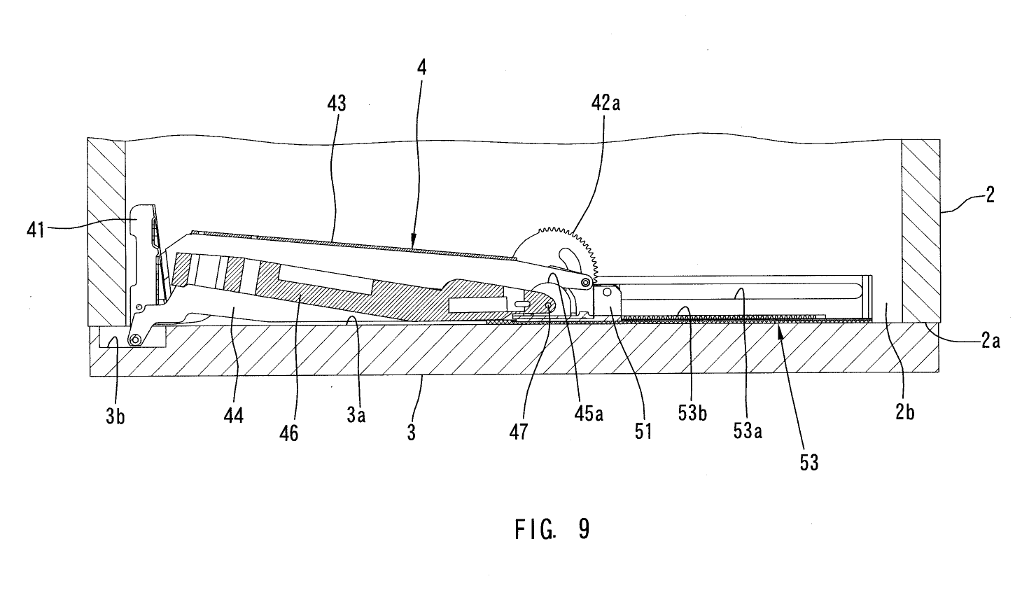

The three rotation axes that are respective rotation centers of the first, second and third links 42, 43, 44 with respect to the body portion 41 are arranged to represent apexes of an equilateral triangle when viewed from longitudinal directions of the three rotation axes. Moreover, the rotation axis of the third link 44 is positioned in front of the rotation axis of the first link 42 such that a line connecting the rotation axis of the first link 42 and the rotation axis of the third link 44 are generally orthogonal to the front surface 2a. As a result, a distal end portion of the body portion 41 to which the third link 44 is connected is protruded forward (downward in FIG. 9) from the opening 2b. An escape recess 3b is formed in the rear surface 3a of the door 3 to prevent the protruded distal end portion of the body portion 41 from interfering with the door 3 in the closed position. The three rotation axes are not necessarily arranged to represent apexes of an equilateral triangle, but may be arranged to represent apexes of an inequilateral triangle.

Since the respective basal end portions of the first, second and third links 42, 43, 44 can be rotated about the rotation axes oriented in the top-bottom direction, distal end portions of the first, second and third links 42, 43, 44 can be rotated about the respective basal end portions in a horizontal direction. The first, second and third links 42, 43, 44 can be rotated in the horizontal direction even when the body portion 41 is mounted on the inner surface of the right side portion of the housing 2. However, when the body portion 41 is mounted in the upper portion or the lower portion of the housing 2, the rotation axes of the first, second and third links 42, 43, 44 are arranged with the longitudinal direction of the rotation axes oriented in a left-right direction and the respective distal end portions of the first, second and third links 42, 43, 44 can be rotated in the top-bottom direction.

As particularly shown in FIG. 11, the respective distal end portions of the first, second and third links 42, 43, 44 are connected to a connecting member 45 such that the first, second and third links 42, 43, 44 can be respectively rotated about three rotation axes extending in the top-bottom direction parallel to each other. The three rotation axes that are respective rotation centers of the distal end portions of the first, second and third links 42, 43, 44 with respect to the connecting member 45 are arranged to represent apexes of an equilateral triangle. The equilateral triangle is identical with a triangle formed by translating the equilateral triangle formed by the three rotation axes that are the rotation centers of the respective basal end portions of the first, second and third links 42, 43, 44 with respect to the body portion 41. Accordingly, a distance between the two rotation axes of the first link 42, a distance between the two rotation axes of the second link 43 and a distance between the two rotation axes of the third link 44 are equal. As a result, a line connecting the two rotation axes of the first link 42, a line connecting the two rotation axes of the second link 43 and a line connecting the two rotation axes of the third link 44 are parallel to each other. Thus, the body portion 41, the first, second and third links 42, 43, 44 and the connecting member 45 constitute a parallel link mechanism. Therefore, when the first, second and third links 42, 43, 44 are rotated about the respective basal end portions, the connecting member 45 is moved in the front-rear direction and in the left-right direction while maintaining a constant attitude. In other words, the connecting member 45 is swingingly moved maintaining a constant attitude.

The second link 43 has a generally U-shaped cross-sectional configuration. A follower 46 is movably inserted inside the second link 43. A distal end portion of the follower 46 is rotatably connected to the connecting member 45 via a shaft 47. A guide groove 46a is formed in a basal end portion of the follower 46. The guide groove 46a extends forward from a basal end surface of the follower 46 in a generally circular arc configuration. A circular cylinder 48 rotatably disposed in the second link 43 is inserted in the guide groove 46a such that the circular cylinder 48 can be moved in a longitudinal direction of the guide groove 46a. Accordingly, when the second link 43 is rotated, the follower 46 is rotated about the shaft 47. Conversely, when the follower 46 is rotated about the shaft 47, the second link 43 is rotated following the rotation of the follower 46, and consequently, the door 3 is swingingly moved.

A cam surface 45a is formed in the connecting member 45. On the other hand, an elongated hole 46b is formed in a distal end portion of the follower 46. The elongated hole 46b extends in a direction toward and away from the cam surface 45a. A shaft (not shown) having a circular cross-sectional configuration is disposed in the elongated hole 46b such that the shaft is rotatable and movable in a longitudinal direction of the elongated hole 46b. The shaft is pressed to contact the cam surface 45a by a biasing member (not shown) such as a coiled spring disposed in the follower 46. The shaft being pressed to contact the cam surface 45a causes biasing force of the biasing member to be converted into rotationally biasing force that causes the follower 46 to be rotated about the shaft 47. In this case, when the door 3 is positioned between the closed position and a predetermined change point position, the biasing force of the biasing member is converted into the rotationally biasing force that rotates the follower 46 in one direction. When the follower 46 is rotated in one direction by the rotationally biasing force, the door 3 is swingingly moved towards the closed position according to the rotation of the follower 46. Therefore, when the door 3 is put in a condition where the door 3 can be freely swingingly moved between the closed position and the change point position, the door 3 is swingingly moved to the closed position by the rotationally biasing force to the one direction and then maintained at the closed position. On the other hand, when the door 3 is located between the change point position and the open position, the biasing force of the biasing member is converted into the rotationally biasing force that rotates the follower 46 in the other direction. When the follower 46 is rotated to the other direction by the rotationally biasing force to the other direction, the door 3 is swingingly moved to the open position according to the rotation of the follower 46. Therefore, when the door 3 is put in a condition where the door 3 can be freely swingingly moved between the open position and the change point position, the door 3 is swingingly moved to the open position by the rotationally biasing force to the other direction, and then maintained at the open position.

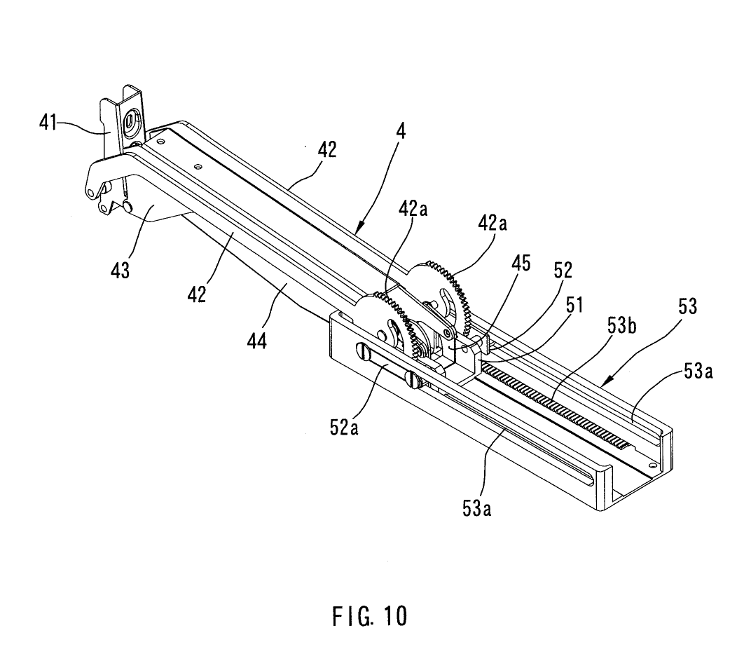

A support member 51 is fixed to the connecting member 45. The support member 51 has a generally U-shaped cross-sectional configuration and is fixed to the connecting member 45 such that the support member 51 receives a front portion (lower portion in FIGS. 10 and 11) of the connecting member 45 inside the support member 51. Guide members 52 are respectively fixed to opposite side surfaces of the support member 51 oriented in the up-down direction (left-right direction in FIGS. 10 and 11). A protruded portion 52a is formed in the guide member 52. The protruded portion 52a is generally horizontally disposed with a longitudinal direction of the protruded portion 52a oriented in the left-right direction. Therefore, the protruded portion 52a is parallel to the front surface 2a of the housing 2. The support member 51 and the guide member 52 may be integrally formed with the connecting member 45.

A movable member 53 is supported by the support member 51 such that the movable member 53 can be moved in the left-right direction. To be more in detail, the movable member 53 has a generally U-shaped cross-sectional configuration and is horizontally disposed with an open portion of the movable member 53 oriented rearward in the horizontal direction and with a longitudinal direction of the movable member 53 oriented in the left-right direction. The connecting member 45, the support member 51 and the guide member 52 are inserted in the movable member 53 such that the connecting member 45, the support member 51 and the guide member 52 are movable in the left-right direction. Guide holes 53a, 53a are respectively formed in opposite side walls of the movable member 53 located in a top and a bottom of the movable member 53. The guide holes 53a, 53a respectively extend through the opposite side walls in the top-bottom direction. The guide holes 53a are elongated holes and are horizontally disposed with a longitudinal direction thereof oriented in the left-right direction. The protruded portions 52a, 52a are respectively inserted in the guide holes 53a, 53a such that the protruded portions 52a, 52a are slidable in the longitudinal direction. By this arrangement, the movable member 53 is supported by the support member 51 such that the movable member 53 can be moved in the left-right direction, and thereby the movable member 53 is supported by the connecting member 45 such that the movable member 53 can be moved in the left-right direction. The movable member 53 is not movable with respect to the connecting member 45 in directions other than the left-right direction.

The movable member 53 is fixed to the rear surface 3a of the door 3. Therefore, when the connecting member 45 is swingingly moved, the door 3 is swingingly moved together with the connecting member 45, the support member 51 and the movable member 53. Moreover, when the movable member 53 is rectilinearly moved with respect to the support member 51 (connecting member 45) in the left-right direction, the door 3 is moved in the left-right direction with respect to the connecting member 45 together with the movable member 53.

To be more in detail, an outer gear portion (gear portion) 42a is formed in an outer circumferential surface of the distal end portion of the first link 42. The outer gear portion 42a is disposed such that an axis of the outer gear portion 42a coincides with the rotation axis of the first link 42 with respect to the connecting member 45. A rack portion 53b is formed in a bottom surface of the movable member 53 opposed to the outer gear portion 42a. The rack portion 53b extends in the left-right direction and is constantly engaged with the outer gear portion 42a. That is, when the door 3 is in any position between the closed position and the open position, the rack portion 53b is engaged with the outer gear portion 42a.

When the first link 42 is rotated, the outer gear portion 42a is rotated with respect to the connecting member 45 and the movable member 53. Therefore, when the door 3 is swingingly moved and the first link 42 is rotated accompanying the swinging movement of the door 3, the movable member 53 is rectilinearly moved in the left-right direction by the engagement of the outer gear portion 42a with the rack portion 53b, and thereby the door 3 is rectilinearly moved in the left-right direction. In this case, when the first link 42 is rotated in one direction (to be referred to as “opening direction” hereinafter), the door 3 is moved in the left direction, that is the direction from the closed position toward the open position. Conversely, when the first link 42 is rotated in the other direction (to be referred to as “closing direction” hereinafter), the door 3 is moved in the right direction, that is the direction from the open position toward the closed position.

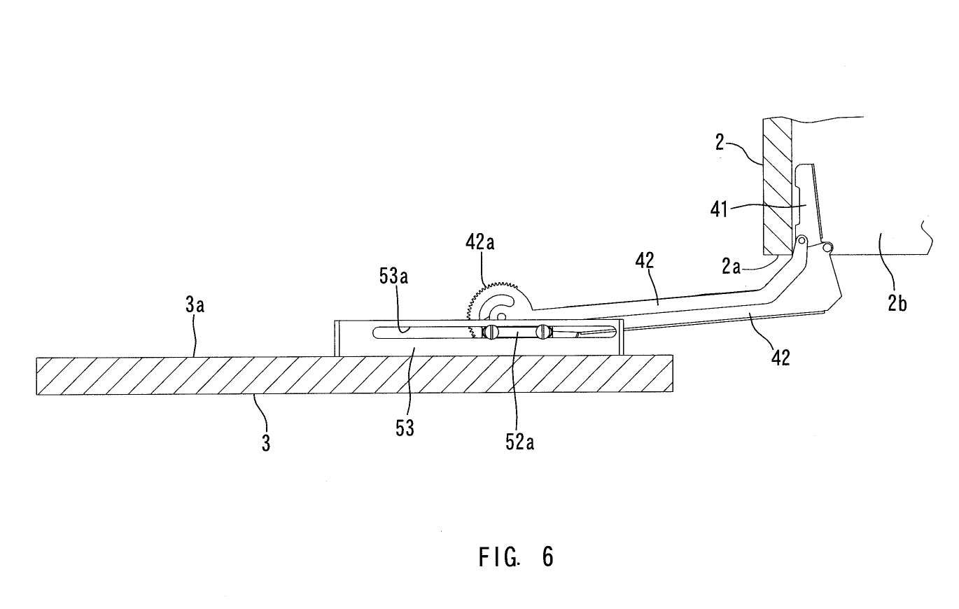

In the door opening and closing apparatus 1 having the above-mentioned construction, let us assume that the door 3 is in the closed position. In this condition, the door 3 is maintained in the closed position by the rotationally biasing force based on the biasing force of the biasing member. Therefore, in order to swingingly move the door 3 from the closed position toward the open position, the door 3 should be drawn forward against the rotationally biasing force. Thereby, the door 3 can be swingingly moved from the closed position toward the open position. When the door 3 is moved beyond the change point position, the door 3 is rotated toward the open position by the rotationally biasing force based on the biasing force of the biasing member. Then, as shown in FIG. 6, the first link 42 is abutted against the housing 2 when the door 3 reaches the open position. Thereby, the door 3 is stopped at the open position and maintained at the open position by the rotationally biasing force.

When the door 3 is swingingly moved from the closed position to the open position, the door 3 is moved to the left as well as in the front-rear direction in the swinging movement accompanying the rotation of the first, second and third links 42, 43, 44 in the opening direction. Regarding the movement in the front-rear direction, the door 3 is moved forward accompanying the swinging movement from the closed position to the change point position. The door 3 is moved backward accompanying the swinging movement from the change point position to the open position. On the other hand, regarding the movement to the left, the door 3 is moved to the left all the time while the door 3 is swingingly moved from the closed position to the open position.

While the door 3 is moved from the closed position to the open position, the door 3 is moved to the left by the engagement of the outer gear portion 42a with the rack portion 53b. Therefore, at the same time with the movement to the left by the swinging movement, the door 3 is moved to the left by the engagement of the outer gear portion 42a with the rack portion 53b. Thus, the door 3 can be moved greatly to the left. As a result, the door 3 can be spaced from the housing 2 to the left, thereby opening the entirety of the opening 2b.

The door 3 can be moved from the open position to the closed position in the reverse order from the above. That is, the door 3 in the open position is moved forward against the rotationally biasing force based on the biasing force of the biasing member, and the door 3 is swingingly moved from the open position toward the closed position. When the door 3 is moved beyond the change point position, the door 3 is swingingly moved toward the closed position by the rotationally biasing force based on the biasing force of the biasing member. During all the time while the door 3 is swingingly moved from the open position toward the closed position, the door 3 is moved to the right by the engagement of the outer gear portion 42a with the rack portion 53b. When the door 3 reaches the closed position, the door 3 is maintained at the closed position by the rotationally biasing force based on the biasing force of the biasing member.

As mentioned above, in the door opening and closing apparatus 1, the movement of the door 3 in the left-right direction due to the engagement of the outer gear portion 42a with the rack portion 53b is made at the same time with the swinging movement of the door 3. Therefore, it is not required to move the door 3 in two steps, such as swingingly moving the door 3 first and then rectilinearly moving the door 3 in the left-right direction. Instead, the door 3 can be moved between the closed position and the open position by one continuous opening/closing operation. Thus, the door 3 can be opened and closed with less trouble.

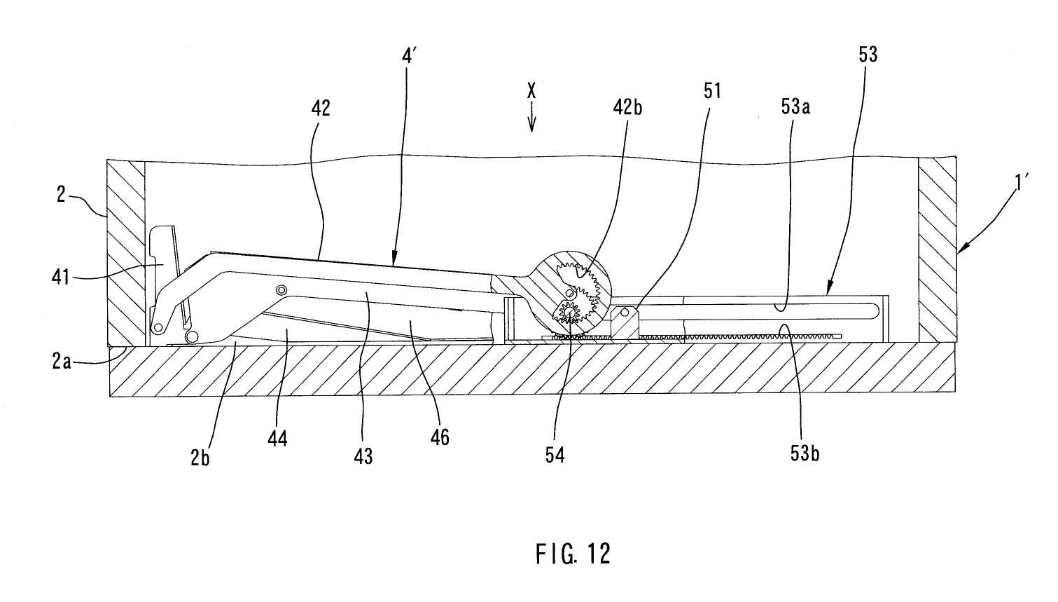

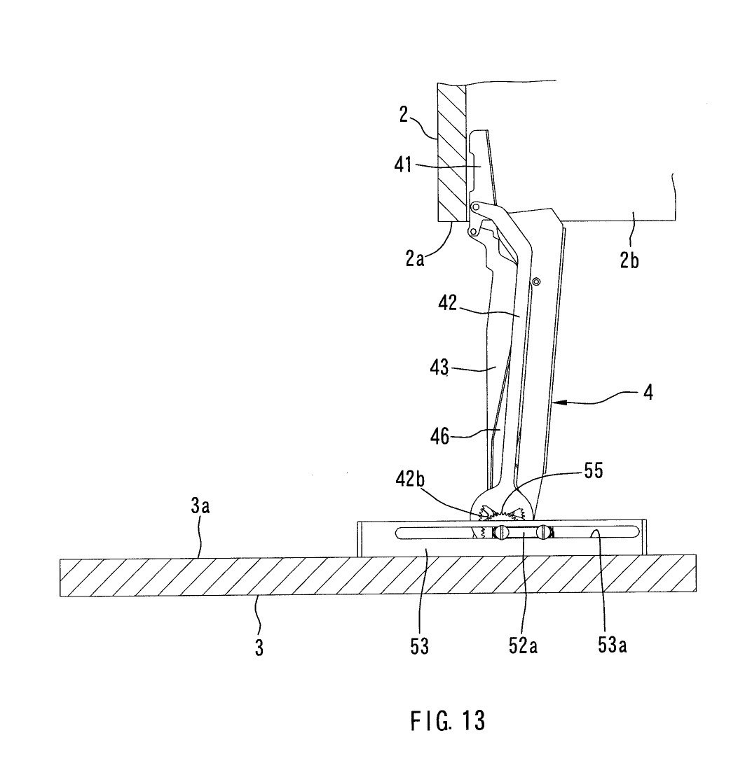

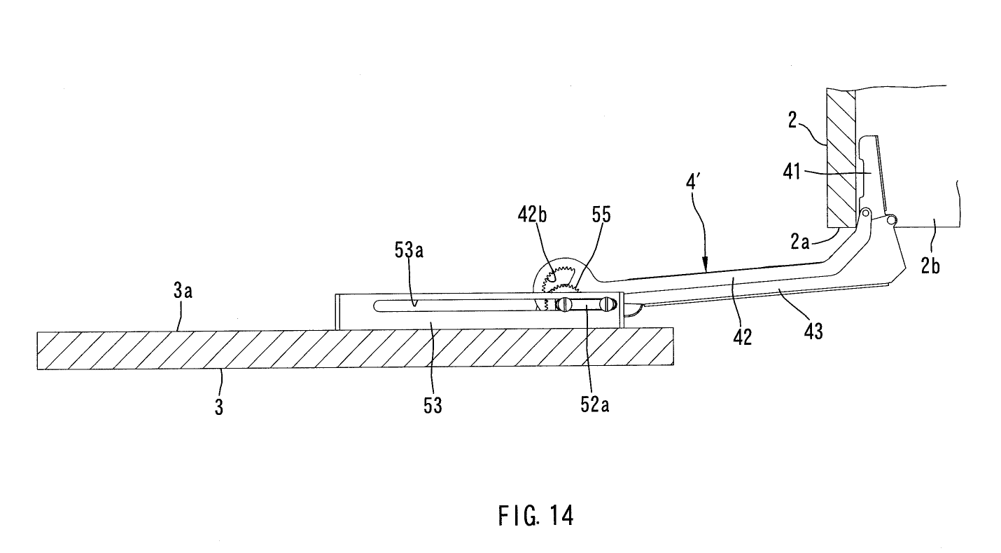

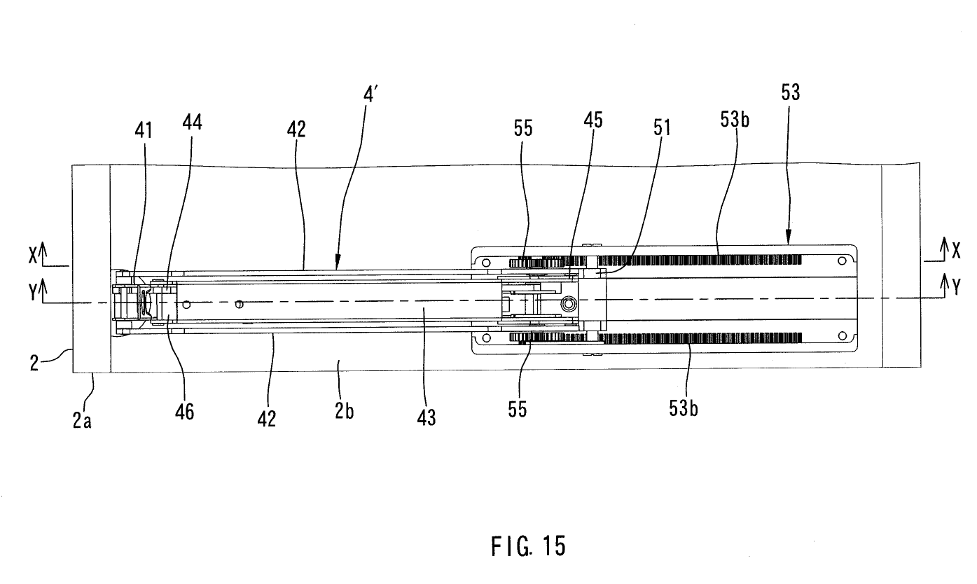

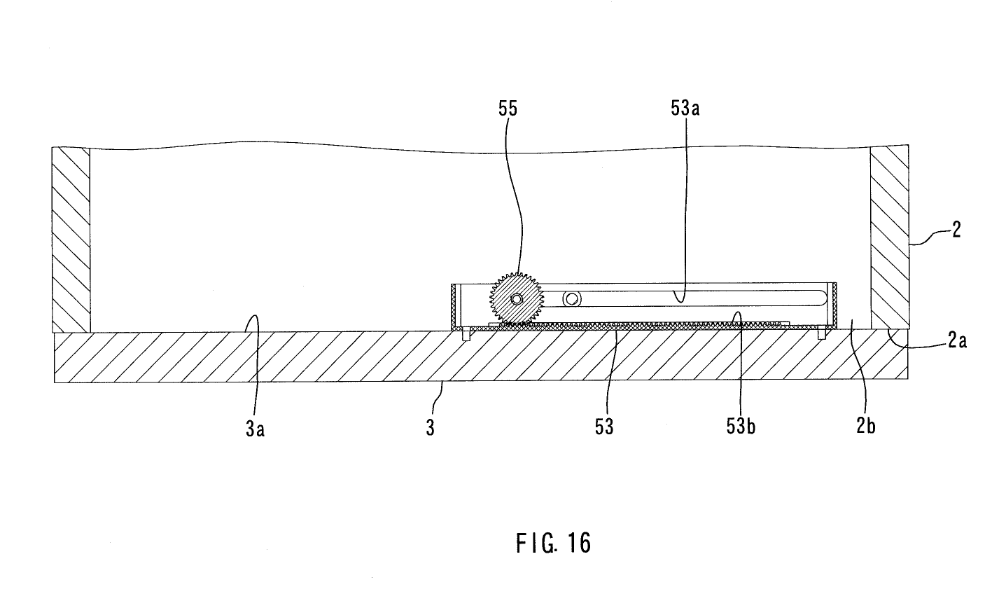

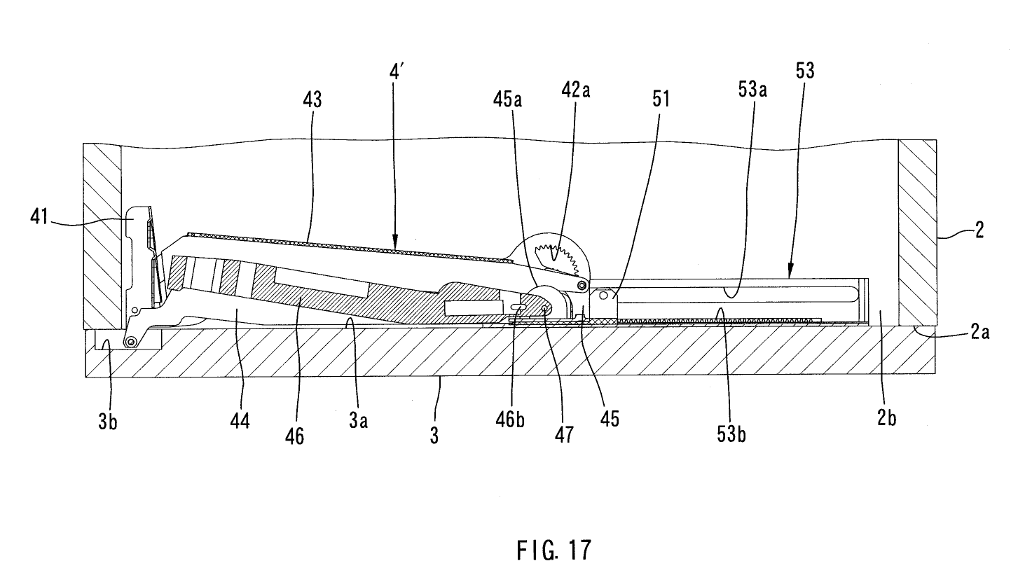

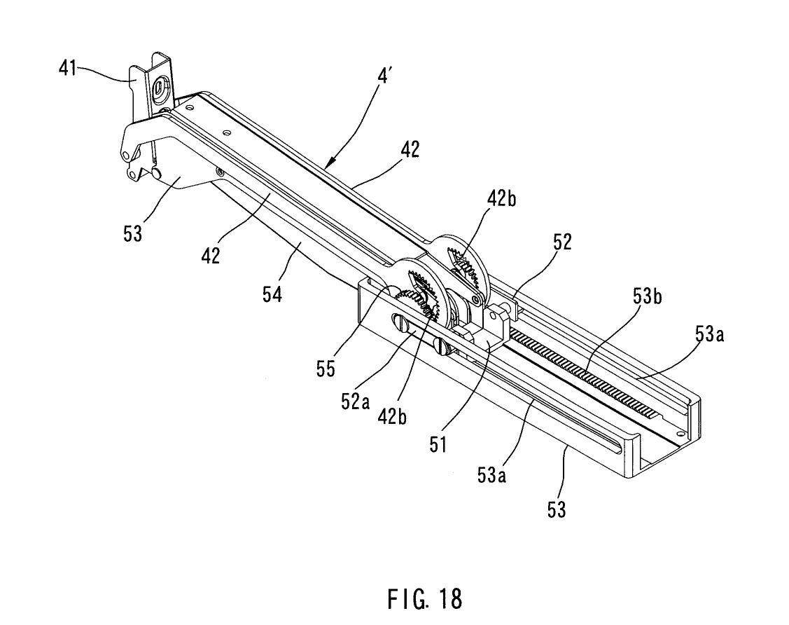

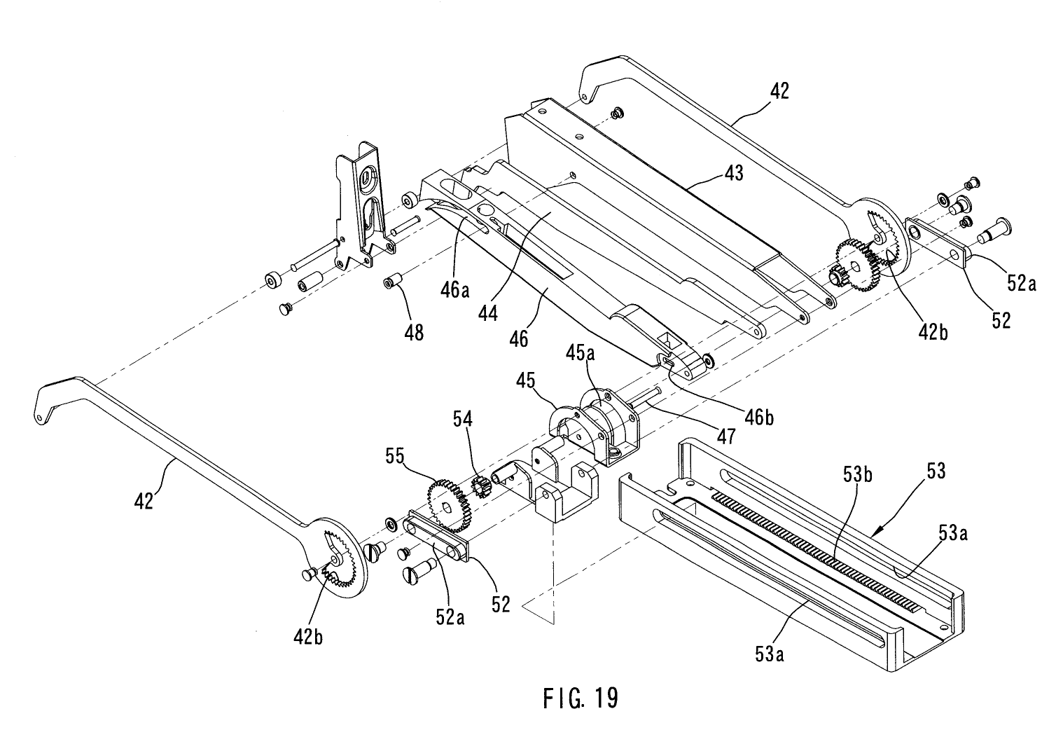

A second embodiment of the present invention shown in FIGS. 12 to 19 will be described next. In the description of the second embodiment, only the features different from those in the first embodiment will be described. The same reference numerals will be used to designate the same elements as the first embodiment and the description thereof will be omitted.

In a door opening and closing apparatus 1′ of the second embodiment, a hinge apparatus 4′ is used instead of the hinge apparatus 4. An inner gear portion 42b is formed in the distal end portion of the first link 42 of the hinge apparatus 4′. The inner gear portion 42b is disposed with an axis thereof coincided with the rotation axis of the first link 42 with respect to the connecting member 45.

A pinion 54 is rotatably disposed in the support member 51. The pinion 54 is disposed such that an axis of the pinion 54 is parallel to the axis of the inner gear portion 42b. The pinion 54 is engaged with the inner gear portion 42b. Therefore, when the first link 42 is rotated with respect to the connecting member 45 and the support member 51, the pinion 54 is rotated.

An outer gear (gear portion) 55 is rotatably disposed in the support member 51. The outer gear 55 has more teeth than the pinion 54. The outer gear 55 is coaxially and non-rotatably connected to the pinion 54. Therefore, when the first link 42 is rotated with respect to the connecting member 45, the rotation of the first link 42 is transmitted to the outer gear 55 via the inner gear portion 42b and the pinion 54. The outer gear 55 is constantly engaged with the rack portion 53b of the movable member 53. Therefore, when the first link 42 is rotated in the opening and closing directions, the movable member 53 and the door 3 are moved in the left-right direction. As is clear from the above, the inner gear portion 42b and the pinion 54 constitute a rotation transmission mechanism that transmits the rotation of the first link 42 with respect to the connecting member 45 to the outer gear 55.

In the door opening and closing apparatus 1′ having the above-mentioned constitution, when the door 3 is swingingly moved in the opening and closing directions, the door 3 is moved in the left-right direction by the engagement of the outer gear 55 with the rack portion 53b. Moreover, the rotation of the first link 42 is transmitted to the outer gear 55 at an increased rotation speed by the engagement of the inner gear portion 42b with the pinion 54. Therefore, an amount of movement of the door 3 in the left-right direction by the engagement of the outer gear 55 with the rack portion 53b can be increased. Thus, an amount of rotation of the first link 42 required for moving the door 3 between the closed position and the open position can be reduced. In other words, even when the amount of rotation of the first link 42 is reduced, the door 3 can be sufficiently moved from the closed position to the open position.

It is to be understood that the present invention is not limited to the embodiments described herein. Various alternatives and modifications can be made without departing from the spirit and scope of the invention.

For example, although the first, second and third links 42, 43, 44 are mounted to the housing 2 via the body portion 41 in the embodiments described above, the first, second and third links 42, 43, 44 may be directly mounted to the housing 2. Moreover, the connecting member 45 may be directly mounted to the door 3 in a movable manner and the movable member 53 may be omitted. In this case, a rack portion serving as a guide portion is disposed in the door 3.

Moreover, although two first links 42 are used in the embodiments described above, it is acceptable that either one of the links 42 is used. Furthermore, either one of the second and third links 43, 44 may be omitted, and only the other one of the second and third links 43, 44 may be used.

Moreover, in the embodiments described above, the outer gear portion 42a (outer gear 55) and the rack portion 53b are engaged to move the movable member 53 in the left-right direction. However, a friction wheel (rolling portion) may be used instead of the outer gear portion 42a (outer gear 55) and a guide portion such as a rail portion made from a material having a friction resistance large enough to allow the friction wheel to roll without slipping may be used instead of the outer gear portion 42a (outer gear 55).

### INDUSTRIAL APPLICABILITY

Application of the hinge apparatus and the door opening and closing apparatus according to the present invention may include a container box in which an opening of a housing is opened and closed by a door.

REFERENCE SIGNS LIST
1 door opening and closing apparatus
1′ door opening and closing apparatus
2 housing
2a front surface (one end surface)
2b opening
3 door
4 hinge apparatus
4′ hinge apparatus
41 body portion (base member)
42 first link
42a outer gear portion (gear portion)
42b inner gear portion
43 second link
45 connecting member
53 movable member
53b rack portion
54 pinion
55 outer gear (gear portion)

1. A hinge apparatus comprising:
a base member;
a first link, a basal end portion of the first link rotatably connected to the base member;
a second link, a basal end portion of the second link rotatably connected to the base member;
a connecting member rotatably connected to a distal end portion of the first link and a distal end portion of the second link, the base member, the first link, the second link and the connecting member constituting a parallel link mechanism; and,
a movable member connected to the connecting member in a rectilinearly movable manner;
wherein a rolling portion is disposed in one of the distal end portion of the first link and the connecting member, the rolling portion rotated accompanying a rotation of the first link with respect to the connecting member;
a guide portion is disposed in the movable member, the guide portion extending in a direction of movement of the movable member; and,
the movable member is rectilinearly moved with respect to the connecting member by the rolling movement of the rolling portion on the guide portion accompanying the rotation of the first link.

2. The hinge apparatus according to claim 1 wherein the rolling portion is a gear portion and the guide portion is a rack portion engageable with the gear portion.

3. The hinge apparatus according to claim 2 wherein the gear portion is disposed in the distal end portion of the first link with an axis of the gear portion coinciding with a rotation axis of the first link with respect to the connecting member.

4. The hinge apparatus according to claim 2 wherein the gear portion is rotatably disposed in the connecting member, a rotation transmission mechanism is provided between the first link and the gear portion, the rotation transmission mechanism transmitting the rotation of the first link with respect to the connecting member to the gear portion.

5. The hinge apparatus according to claim 4 wherein the rotation transmission mechanism comprises an inner gear portion and a pinion, the inner gear portion disposed in the distal end portion of the first link with an axis of the inner gear portion coinciding with the rotation axis of the first link with respect to the connecting member, the pinion being engageable with the inner gear portion, and the gear portion is non-rotatably connected to the pinion with the axis of the gear portion coinciding with an axis of the pinion.

6. A door opening and closing apparatus comprising:
a housing having an opening in an one end surface thereof; and
a door mounted to the housing via a hinge apparatus such that the door is movable between a closed position and an open position, the door closing the opening when the door is in the closed position, the door opening the opening when the door is in the open position,
the hinge apparatus comprising:
a first link, a basal end portion of the first link rotatably connected to the housing;
a second link, a basal end portion of the second link rotatably connected to the housing; and
a connecting member rotatably connected to a distal end portion of the first link and a distal end portion of the second link, the housing, the first link, the second link and the connecting member constituting a parallel link mechanism;
the door connected to the connecting member such that the door is movable in opening and closing directions generally along an one end surface in which the opening of the housing is formed;
wherein a rolling portion is disposed in one of the distal end portion of the first link and the connecting member, the rolling portion rotated accompanying a rotation of the first link with respect to the connecting member;
a guide portion is disposed in the door, the guide portion extending in the opening and closing directions; and,
the door is moved in the opening and closing directions with respect to the connecting member by the rolling movement of the rolling portion on the guide portion accompanying the rotation of the first link.

7. The door opening and closing apparatus according to claim 6 wherein the rolling portion is a gear portion and the guide portion is a rack portion engageable with the gear portion.

8. The door opening and closing apparatus according to claim 7 wherein the gear portion is disposed in the distal end portion of the first link with an axis of the gear portion coinciding with a rotation axis of the first link with respect to the connecting member.

9. The door opening and closing apparatus according to claim 7 wherein the gear portion is rotatably disposed in the connecting member, a rotation transmission mechanism is provided between the first link and the gear portion, the rotation transmission mechanism transmitting the rotation of the first link with respect to the connecting member to the gear portion.

10. The door opening and closing apparatus according to claim 9 wherein the rotation transmission mechanism comprises an inner gear portion and a pinion, the inner gear portion disposed in the distal end portion of the first link with an axis of the inner gear portion coinciding with the rotation axis of the first link with respect to the connecting member, the pinion being engageable with the inner gear portion, and the gear portion is non-rotatably connected to the pinion with the axis of the gear portion coinciding with an axis of the pinion.
